(19) United States
(12) Patent Application Publication
(10) Pub. No.: US 2014/0058828 A1
(43) Pub. Date: Feb. 27, 2014

(54) OPTIMIZING MEDIA BASED ON MENTAL STATE ANALYSIS

(71) Applicant: Affectiva, Inc., Watham, MA (US)

(72) Inventors: Rana el Kaliouby, Boston, MA (US); Melissa Sue Burke, Boston, MA (US); Andrew Edwin Dreisch, San Jose, CA (US); Panu James Turcot, San Francisco, CA (US); Evan Kodra, Waltham, MA (US)

(73) Assignee: Affectiva, Inc., Watham, MA (US)

(21) Appl. No.: 14/068,919

(22) Filed: Oct. 31, 2013

Related U.S. Application Data
(63) Continuation-in-part of application No. 13/153,745, filed on Jun. 6, 2011.
Application No. 13/153,745 is a continuation-in-part of application No. 13/708,214, filed on Dec. 7, 2012.
(60) Provisional application No. 61/747,651, filed on Dec. 31, 2012.
(60) Provisional application No. 61/747,810, filed on Dec. 31, 2012.
(60) Provisional application No. 61/793,761, filed on Mar. 15, 2013.
(60) Provisional application No. 61/790,461, filed on Mar. 15, 2013.
(60) Provisional application No. 61/789,038, filed on Mar. 15, 2013.
(60) Provisional application No. 61/798,731, filed on Mar. 15, 2013.
(60) Provisional application No. 61/844,478, filed on Jul. 10, 2013.
(60) Provisional application No. 61/352,166, filed on Jun. 7, 2010.
(60) Provisional application No. 61/388,002, filed on Sep. 30, 2010.
(60) Provisional application No. 61/414,451, filed on Nov. 17, 2010.
(60) Provisional application No. 61/439,913, filed on Feb. 6, 2011.
(60) Provisional application No. 61/447,089, filed on Feb. 27, 2011.
(60) Provisional application No. 61/447,464, filed on Feb. 28, 2011.
(60) Provisional application No. 61/467,209, filed on Mar. 24, 2011.
(60) Provisional application No. 61/568,130, filed on Dec. 7, 2011.
(60) Provisional application No. 61/581,913, filed on Dec. 30, 2011.

(51) Int. Cl. G06Q 30/02

(52) U.S. Cl. CPC G06Q 30/0244
USPC 705/14.43

(57) ABSTRACT

Mental state data is collected from a group of people as they view a media presentation, such as an advertisement, a television show, or a movie. The mental state data is analyzed to produce mental state information, such as inferred mental states, facial expressions, or valence. The mental state information is used to automatically optimize the previously viewed media presentation. The optimization may change various aspects of the media presentation including the length of different portions of the media presentation, the overall length of the media presentation, character selection, music selection, advertisement placement, and brand reveal time.

### RELATED APPLICATIONS

This application claims the benefit of U.S. provisional patent applications “Optimizing Media Based on Mental State Analysis” Ser. No. 61/747,651, filed Dec. 31, 2012, “Collection of Affect Data from Multiple Mobile Devices” Ser. No. 61/747,810, filed Dec. 31, 2012, “Mental State Analysis Using Heart Rate Collection Based on Video Imagery” Ser. No. 61/793,761, filed Mar. 15, 2013, “Mental State Data Tagging for Data Collected from Multiple Sources” Ser. No. 61/790,461, filed Mar. 15, 2013, “Mental State Analysis Using Blink Rate” Ser. No. 61/789,038, filed Mar. 15, 2013, “Mental State Well Being Monitoring” Ser. No. 61/798,731, filed Mar. 15, 2013, and “Personal Emotional Profile Generation” Ser. No. 61/844,478, filed Jul. 10, 2013. This application is also a continuation-in-part of U.S. patent application “Mental State Analysis Using Web Services” Ser. No. 13/153,745, filed Jun. 6, 2011 which claims the benefit of U.S. provisional patent applications “Mental State Analysis Through Web Based Indexing” Ser. No. 61/352,166, filed Jun. 7, 2010, “Measuring Affective Data for Web-Enabled Applications” Ser. No. 61/388,002, filed Sep. 30, 2010, “Sharing Affect Data Across a Social Network” Ser. No. 61/414,451, filed Nov. 17, 2010, “Using Affect Within a Gaming Context” Ser. No. 61/439,913, filed Feb. 6, 2011, “Recommendation and Visualization of Affect Responses to Videos” Ser. No. 61/447,089, filed Feb. 27, 2011, “Video Ranking Based on Affect” Ser. No. 61/447,464, filed Feb. 28, 2011, and “Baseline Face Analysis” Ser. No. 61/467,209, filed Mar. 24, 2011. This application is also a continuation-in-part of US patent application “Affect Based Evaluation of Advertisement Effectiveness” Ser. No. 13/708,214, filed Dec. 7, 2012 which claims the benefit of U.S. provisional patent applications “Mental State Evaluation Learning for Advertising” Ser. No. 61/568,130, filed Dec. 7, 2011 and “Affect Based Evaluation of Advertisement Effectiveness” Ser. No. 61/581,913, filed Dec. 30, 2011. The foregoing applications are each hereby incorporated by reference in their entirety.

### FIELD OF ART

This application relates generally to analysis of mental states and more particularly to optimizing media based on mental states.

### BACKGROUND

Evaluation of mental states is key to understanding people and the way in which they react to the world around them. Mental states run a broad gamut from happiness to sadness, from contentedness to worry, and from excited to calm, among numerous other mental states. Mental states are experienced in response to everyday events such as frustration during a traffic jam, boredom while standing in line, and impatience while waiting for a cup of coffee. Individuals' sense of empathy and perception may pique based on evaluating and understanding others' mental states; reacting in the moment in response to the mental states of other people. While an empathetic person may perceive another person's mental state—whether anxious, joyful, or sad—and respond accordingly, automated evaluation of mental states is far more challenging. A person may feel that they perceive another's emotional state quickly and instinctually, with a minimum of conscious effort. Thus, the ability and manner by which a person identifies another person's mental state may be difficult to classify, summarize, or communicate.

Many mental states, such as confusion, concentration, and worry, may be identified to aid in the understanding of an individual or group of people. For example, people can collectively respond to an external stimulus with fear or anxiety, such as after witnessing a catastrophe. Likewise, people can collectively respond to an external stimulus with happy enthusiasm, such as when their sports team wins a major victory. Certain facial expressions and head gestures may be used to identify a mental state that a person is experiencing. In this field, limited automation has been performed in the area of evaluation of mental states based on facial expressions. For example, certain physiological conditions—conditions which may provide telling indications of a person's state of mind—are already used in a crude fashion to identify a person's mental state, as seen in an apparatus used for lie detector or polygraph tests.

Some systems for analyzing mental states are currently in use, such as the Facial Action Coding System (FACS), a detailed catalog of unique action units that correspond to independent motions of the face. Traditionally FACS data has been manually collected by an observer of the subject and later analyzed to determine various emotions. Another system in wide use for analyzing mental states is the rating dial. A rating dial is a hardware dial that can be manipulated by a subject to indicate their interest, like/dislike, or another emotion on a scale measured over time. Rating dials have been used for a variety of applications, including monitoring couples' feelings during conversations with each other and monitoring audience reactions during political debates.

### SUMMARY

A computer is used to collect mental state data from a group of people as they view a media presentation such as an advertisement, a television show, or a movie, and to analyze the mental state data produce mental state information such as mental states, facial expressions, or valence. The mental state information is then used to optimize the media presentation. The optimization changes various aspects of the media presentation including, but not limited to, length of various portions of the media presentation, the overall length of the media presentation, selecting characters, selecting music, determining advertisement placement, or determining a brand reveal time. A computer-implemented method for media analysis is disclosed comprising: collecting mental state data from a plurality of people as they view a media presentation; analyzing the mental state data to produce mental state information; and optimizing the media presentation based on the mental state information. Often, the collecting of the mental state data from the plurality of people is performed over multiple viewings of the media presentation. In embodiments, advertisement placement is determined within the media presentation as part of the optimizing. In some embodiments, an optimal number of viewings is determined for the media presentation as part of the optimizing. In embodiments, norms are developed based on a plurality of media presentations where the norms are used in the optimizing of the media presentation.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for advertisement optimization.

FIG. 2 is a flow diagram showing example advertisement optimization techniques.

FIG. 3 is a system diagram for capturing mental state data.

FIG. 4 is an example dashboard diagram for mental state analysis.

FIG. 5 is a graphical representation of mental state analysis.

FIG. 6 is an example advertisement dashboard for mental state analysis.

FIG. 7 is an example advertisement dashboard for valence analysis.

FIG. 8 is a system diagram for evaluating mental states.

### DETAILED DESCRIPTION

The generation, editing, and improvement of media presentations such as advertisements, movies, and television programs have traditionally involved using experienced media practitioners to analyze and optimize media products before release. The result has been erratic, as even with the guidance of highly experienced media practitioners, numerous television shows are quickly cancelled after initial release and numbers of advertisements vastly underperform expectations. A quantifiable measurement of affect could have a profound impact on the optimization of media content. Television shows and movies aim to interest and entertain millions, and advertisements are intended to move large numbers of people to purchase a product or change their attitude. Before an advertisement, TV show, or movie is launched, content providers often test content by soliciting feedback from a consumer panel. The results of this testing may be used to optimize the content or, in the case of a television show, assess audience engagement with certain characters in the show. In one traditional measurement method, panelists are asked to turn a hardware dial to quantify valence throughout the show. In such studies, dial values, which may be collected at discrete time intervals such as once per second, may range from 0 to 100. In this case, the panelists may be told that a value of 0 signifies disinterest, a value of 50 represents neutral feelings, and a value of 100 demonstrates interest in the show.

While the dial approach has been used for many years, it has several drawbacks. First, its use requires the recruitment and physical coordination of panelists, typically in a limited geographic and demographic locale. Second, the production of reliable, continuously measured, and accurately aggregated measurements of affective response requires large consumer panels. Third, analysis is limited to one-dimensional dial data; there is no way of collecting data on various discrete mental states such as excitement, happiness, and surprise, all of which might correspond to a positive valance. Further, unforeseen effects may be caused by asking a panelist to turn a dial while engaging with content. Some panelists may experience heavy cognitive load from having to manipulate a dial, which may in turn distract them from the media experience and add difficult-to-quantify noise to their response. In another case, a panelist may become engrossed in the media experience and forget to turn the dial when their affective state changes. In both cases the reports may not match their true mental state. That is, the act of labeling affect itself can significantly impact an individual's affect response.

The human face is a powerful channel for communicating valence as well as a wide gamut of emotion states. The Facial Action Coding System (FACS) is a detailed catalogue of unique action units that correspond to each independent motion of the face. FACS enables the measurement and scoring of facial activity in an objective, reliable, and quantitative way, and may be used to discriminate between subtle differences in facial motion. Facial behavior may be used to measure the effectiveness of media content. The general expressiveness of viewers as they view media content correlates strongly with their memory of the same content, a key measure of a successful exposure. A camera may be used to capture images of faces, and software may be used to extract FACS data or other mental state information from the images.

Other physiological data may also be useful in determining valance and/or determining mental states, the data including gestures, eye movement, sweating, galvanic skin response (GSR), heart rate, and blood pressure, among others. A variety of sensors can be used to capture physiological data, including heart rate monitors, blood pressure monitors, GSR sensors, or other types of sensors. A camera may be useful for simultaneously capturing physiological data and facial images. The physiological data captured by the webcam can include gestures, eye movement, sweating, or even heart rate, among other physiological data. Software may be used to extract mental state information from the physiological data captured in an image in addition to, or in place of, the FACS data. In some embodiments, self-report methods of capturing mental state information, such as the dial approach, may also be used in conjunction with mental state information produced from the images captured by the camera.

Once the mental state information has been produced, it may be used to automatically optimize the media that was presented while the mental state data was captured. A wide variety of things may be done to optimize the media. In some embodiments, the length of the media, or a section of the media, can be shortened based on the mental state information produced—for example, the length of the media may be shortened based on viewer attention levels. Also, the length of the media may be shortened to fit into a specific time allotment, such as a 30-second commercial. In some embodiments, the time at which a brand is revealed in an advertisement is automatically changed. In some embodiments, the characters or the script are changed based on attitudes inferred from the mental state information. A wide variety of media characteristics may be automatically optimized based on the produced mental state information.

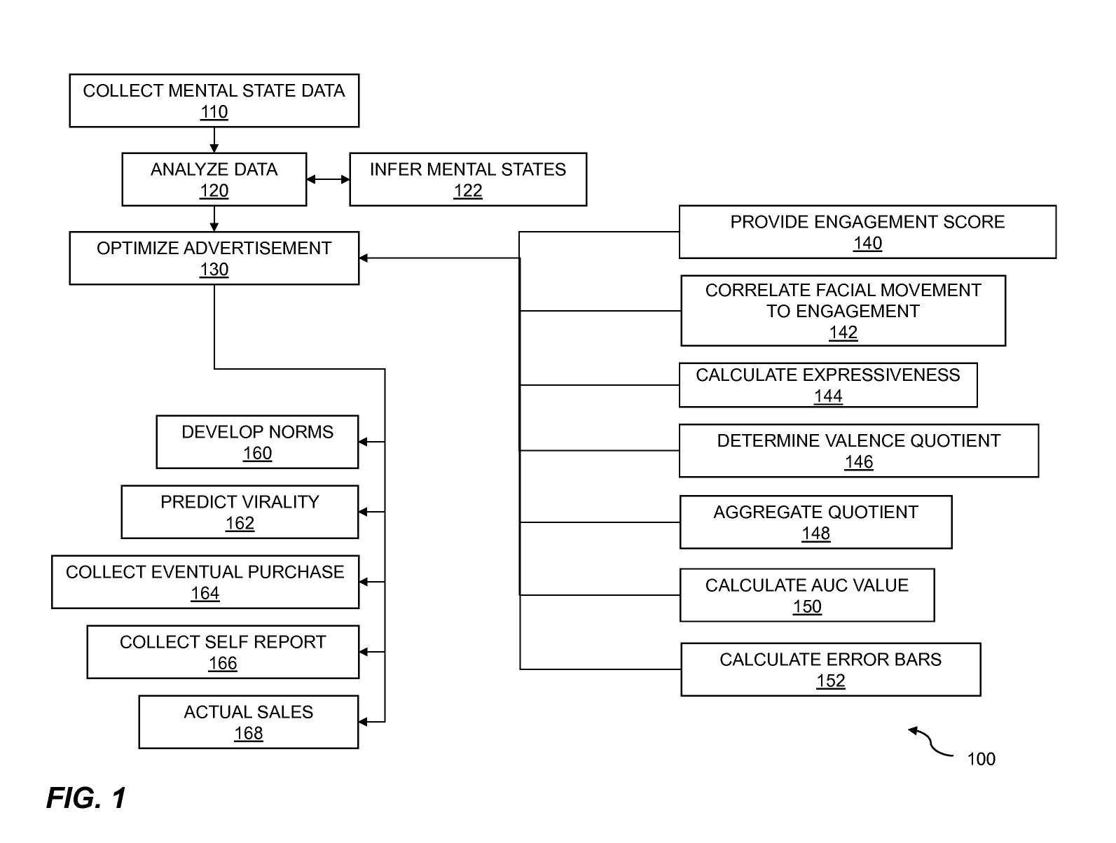

FIG. 1 is a flow diagram for advertisement optimization. The flow 100 describes a computer-implemented method for media analysis, where the media may comprise an advertisement. The flow 100 includes collecting mental state data 110 from a plurality of people as they view a media presentation, analyzing the mental state data 120 to produce mental state information, and optimizing the media presentation 130 based on the mental state information. The collecting mental state data 110 may be done by any method in various embodiments, but may include capturing facial images of, and/or capturing dial settings set by, one or more people exposed to the media. In some embodiments, the media is presented more than once. In an embodiment with multiple presentations, the flow 100 further comprises collecting the mental state data 110 from the plurality of people for multiple viewings of the media presentation. The audience may include substantially the same plurality of people during the multiple viewings or the audience may be substantially different for the multiple viewings. The mental state data may include one or more of smiles, laughter, smirks, or grimaces.

The analyzing of mental state data 120 may include any type of analysis including computation of means, modes, standard deviations, or other statistical calculations over time. This analysis may be computed separately for different demographic groups in the audience, or it may be based on other parameters. The mental state data may be aggregated across a plurality of individuals and various different mental state data may be used to generate mental state information. The analyzing mental state data 120 may include inferring mental states 122, which may be a type of mental state information. In some embodiments, FACS data may be analyzed to infer mental states, such as one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

In some embodiments, the flow 100 may include developing norms 160 based on a plurality of media presentations, and using the norms in the optimizing of the media presentation. Norms may be developed for any of the mental state information that may be produced and may be based on statistical calculations—such as means or modes—or may be based on selected media presentations of the plurality of media presentations that may represent targeted audience reactions. In some embodiments, the norms may be developed manually, based on desired audience reactions, using the mental state information produced during the presentation of the plurality of media presentations.

The flow 100 may include predicting virality 162 for the media presentation. Virality may be a measure of the likelihood of the media presentation “going viral,” or being recommended by viewers to their friends by word-of-mouth, social media, e-mail, or other means of unpaid recommendation or promotion through various media distribution channels. Various methods of predicting virality may be known in the art, such as analyzing the content for subject matter that commonly goes viral,—for example, cute kittens or strange dances—looking at early download numbers after the media is posted, monitoring social media mentions, or any other method that may be found to be useful in predicting virality.

In some embodiments, information on whether individuals from the plurality of people eventually purchase the product 164 may be collected. The purchase information may be collected after the initial collection of mental state data, and may be correlated using an individual, a demographic group, or another grouping. Some embodiments include collecting self-reporting 166 from the plurality of people. The self-reporting may be from dial indicators manipulated by the plurality of people during the media presentation, interviews conducted during or after the media presentation, surveys, or other types of self-reporting. In some embodiments the self-reporting includes information on whether individuals, from the plurality of people, plan to purchase the product. Some embodiments also include evaluating the media presentation based on actual sales 168. The information on actual sales may be collected after the presentation of the media to the plurality of people, before the presentation of the media, or at multiple times before, during, or after the presentation.

Continuing, the optimization of the advertisement 130 may be based on one or more pieces of mental state information produced from the mental state data. In some embodiments, the flow 100 may further comprise providing an engagement score 140 for the media presentation and/or providing an engagement score for portions of the media presentation. In embodiments, the engagement score can allow the optimizing to be based on engagement. The engagement score may be based directly on various action units of the FACS data, may be inferred based on other mental state information, or may be produced by other methods. Thus, the flow 100 may further comprise correlating facial movement to engagement 142. In some embodiments, the expressiveness score for the advertisement is calculated 144 based on total movement for faces of the plurality of people.

The flow 100 may further comprise determining a valence quotient 146. While various embodiments may use any range for the valence quotient, in some cases the valence quotient ranges from −1 to +1—using such a scale, a negative valence quotient represents negative feelings toward the media presentation and a positive valence quotient represents positive feelings toward the media presentation. The media presentation may be optimized to keep the valence quotient away from zero and to minimize indifference toward the media presentation. Various embodiments further comprise aggregating the valence quotient 148, calculating an area-under-the-curve (AUC) value 150 for the valence quotient and/or calculating error bars 152 on the valence quotient. The aggregation, AUC, and/or error bars may be used to guide the optimization and to help understand the validity of the calculated valence quotient.

Various types of optimization may be performed in various embodiments; the optimizing may include making recommendations for changes to the media presentation. In other embodiments, the optimizing occurs automatically under control of software running on a computer with little or no interaction with a human operator. In some embodiments, the optimizing separates a preamble from a remainder of the media presentation. In some embodiments, the optimizing selects one preamble for the media presentation from multiple possible preambles. In some cases, the optimizing correlates to viewer recall of the media presentation, while in other cases the optimizing correlates to brand recall. In various embodiments, the optimizing of the media presentation is based on multiple viewings of the media presentation, and may be based on different responses to the multiple viewings. The optimizing may be targeted for specific environments, such as optimizing for digital signage, optimizing for airport advertisements, optimizing for television viewing, optimizing for mobile viewing, or optimizing for any other environment. In some embodiments, the optimizing is based on the attention of one or more individuals, and the optimizing may be done for one or more individuals. The media presentation may be optimized based on an advertisement objective which includes one or more of a group comprising entertainment, education, awareness, persuasion, startling, and drive to action.

In some embodiments, the optimizing of the media presentation uses one or more effectiveness descriptors and an effectiveness classifier. Mental state information may include one or more effectiveness descriptors to analyze various affect measurements. The affect measurements may include, but are not limited to, valence and various FACS action units such as outer brow raiser action unit 2 (AU2), brow lowerer action unit 4 (AU4), lip corner puller action unit 12 (AU12), and/or other FACS action units. Some descriptors may use a scale to indicate a probability of an affect being present—for example, a value of 0% would definitively indicate that the affect is not present, and a value of 100% would definitively indicate that the affect is present. Probabilities for one or more effectiveness descriptors may vary for portions of the media presentation. Effectiveness classifiers may be created based on the effectiveness descriptors and may be based on a combination of effectiveness descriptors. In some embodiments, the effectiveness classifier is used to project the advertisement effectiveness and optimize the advertisement. Various steps in the flow 100 may be changed in order, repeated, omitted, or the like without departing from the disclosed concepts. Various embodiments of the flow 100 may be included in a computer program product embodied in a non-transitory computer readable medium that includes code executable by one or more processors.

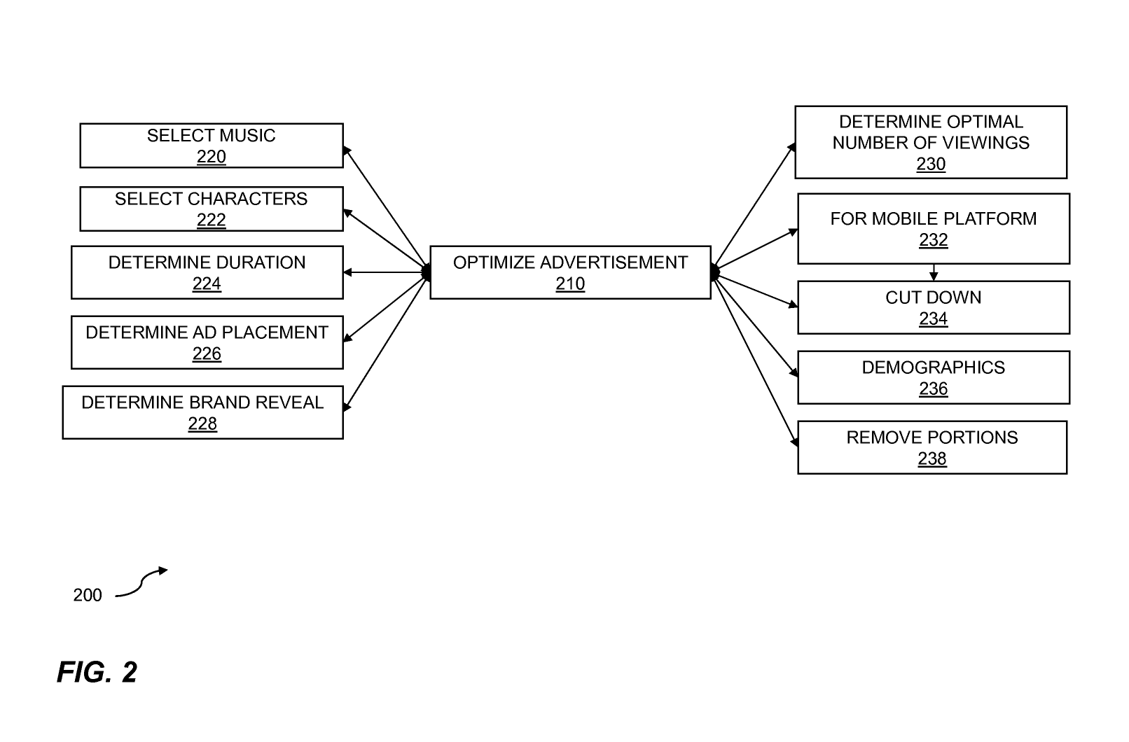

FIG. 2 is a flow diagram 200 showing example advertisement optimization techniques. A wide variety of the advertisement's parameters may be optimized 210, only some of which may be shown in FIG. 2. The flow 200 may include selecting music 220 for the media presentation as part of the optimizing. In at least one embodiment, the media presentation may be automatically prepared with different sound tracks and mental state data may be collected as the different versions are presented in order to determine which music generates the most positive or negative affect data, depending on the goals of the media presentation. Other embodiments will utilize other mental state information or effectiveness descriptors for the optimization. The flow 200 may include selecting characters 222, actors, or roles, for the media presentation as part of the optimizing. Optimizing for characters may be accomplished in a similar manner to the music optimization, with multiple versions of the media presentation created and presented with different characters. Other embodiments may use the mental state information produced as a character is introduced or is present in a scene for the optimization.

The flow 200 may include determining duration 224 for the media presentation as part of the optimizing. Depending on the embodiment, multiple versions of a media presentation with different lengths are created, automatically or manually, and presented to collect mental state data. Alternatively, the mental state information of a single version may be analyzed to see if the audience becomes bored, is expecting more plot development, or desires longer story lines. In at least one embodiment, the optimizing includes cutting down 234 an existing media presentation, which may produce a duration length that is half of an existing duration for the media presentation, a quarter of an existing duration for the media presentation, or another length. In other embodiments, the final length is predetermined, such as 30 seconds or one minute, and the optimizing may cut down the media to fit the predetermined length. In some embodiments, the cutting down may remove the least interesting portions, and/or may retain the most interesting portions in the resulting media presentation. The flow 200 may comprise optimizing the media presentation to remove portions 238 where mental state data indicated confusion, among other possibilities.

The flow 200 may further comprise determining advertisement placement 226 within the media presentation as part of the optimizing. The timing for advertisements can be chosen based on key points of interest by viewers of television programs. By picking the correct time points, viewers can be retained through commercial breaks in a program. Mood congruency can be maintained between a program and an advertisement. Various types of mental state information may be used to automatically determine advertisement placement, such as excitement, interest, or other mental state information. In other embodiments the media presentation may be prepared with advertisements in different locations, with mental state data collected in order to determine which advertisement placement generated the most desirable mental state information. Some embodiments may include determining brand reveal time 228 for the media presentation as part of the optimizing. Determining the brand reveal time within an advertisement may be accomplished similarly to determining advertisement placement in a longer media program. Probabilities, for certain types of affect, may be identified at a segment in the media presentation when a brand is revealed. The flow 200 may further comprise determining an optimal number of viewings 230 for the media presentation as part of the optimizing. Having a fewer number of exposures than the optimal number may reduce brand awareness. Have a higher number may result in fatigue and cause people to change channels or ignore advertisements. The optimal number of viewings may be determined by various methods such as presenting the same media to the same audience or individual multiple times and comparing the affect data from the various presentations.

Some embodiments may optimize for one or more demographic groups 236. Demographic groups may include, but are not limited to, groups with certain political affiliations, groups with similar interests and hobbies, groups within a certain geographic location, and groups with similar socioeconomic metrics, to name a few. For example, an advertisement can be optimized for demographic groups who are primary viewers of certain television programs. By optimizing for the appropriate demographic group of viewers, viewer interest curated during a television program can be retained through an advertisement.

In some embodiments, the media presentation is optimized for a specific platform. The optimizing may include optimizing the media presentation for a mobile platform 232 such as a mobile phone, a tablet computer, or a mobile device. Other embodiments will optimize for a home TV screen, a large movie theatre screen, or a personal computer screen. One such optimization for a particular platform or screen size may be changing print size in the media presentation, for example.

In some embodiments, the optimization occurs off-line after the presentation of the media. Optimization may occur in several steps where the media is presented and mental state data is collected and used to optimize the media. The optimized media may be presented again after the new mental state data has been collected and used to re-optimize the media. This pattern is repeated a number of times in some embodiments. In other embodiments, optimizing is performed in real time as the media presentation is being viewed. Mental state information that is produced for one segment of the media may be used to optimize the next segment of the media. Other embodiments may provide even more interaction between the collected mental state data and the media presentation. Various steps in the flow 200 may be changed in order, repeated, omitted, or the like without departing from the disclosed concepts. Various embodiments of the flow 200 may be included in a computer program product embodied in a non-transitory computer readable medium that includes code executable by one or more processors.

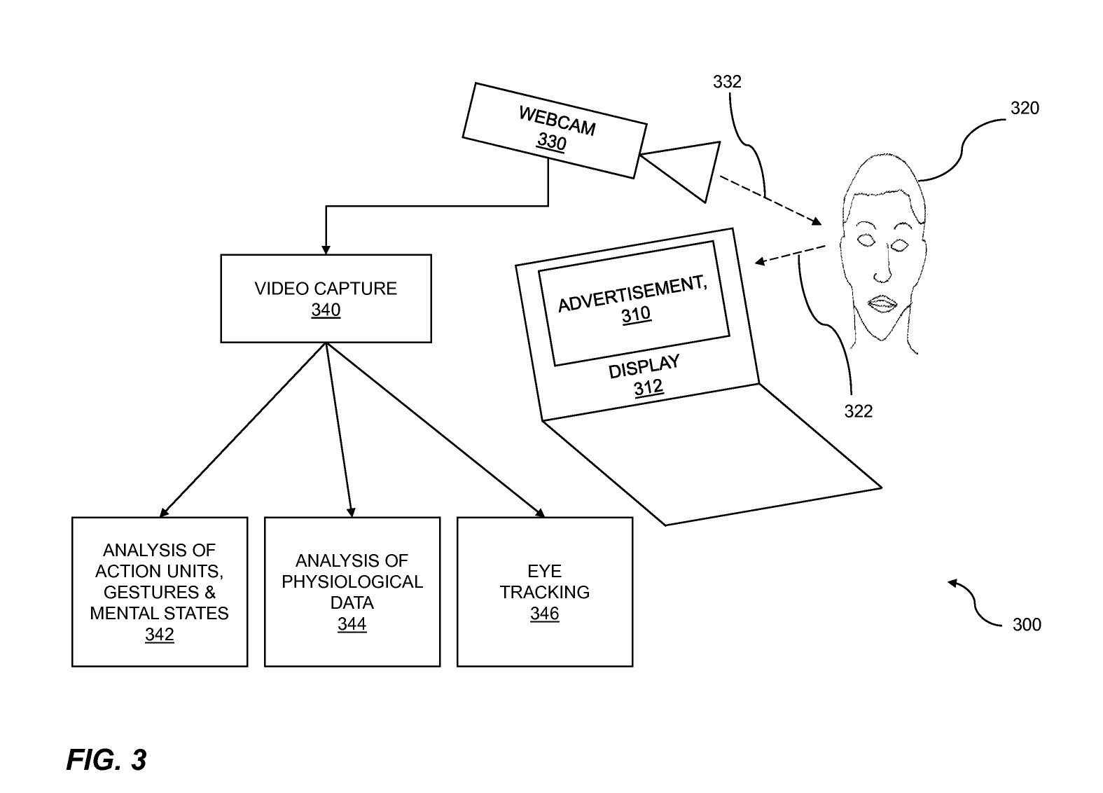

FIG. 3 is a system diagram 300 for capturing mental state data. The media presentation may be viewed on an electronic display 312. The media presentation may be an advertisement 310, a TV program, a movie, or any other type of media presentation. A viewer 320 has a line-of-sight 322 to a display 312. While one viewer has been shown, in practical use, embodiments of the present invention may analyze groups comprising tens, hundreds, or thousands of people or more. Each viewer has a line of sight 322 to the advertisement 310 rendered on a digital display 312. An advertisement 310 may be a political advertisement, an educational advertisement, a product advertisement, a service advertisement, and so on.

The display 312 may be a television monitor, projector, computer monitor (including a laptop screen, a tablet screen, a net book screen, and the like), a projection apparatus, a cell phone display, a mobile device, or other electronic display. A webcam 330 is configured and disposed such that it has a line-of-sight 332 to the viewer 320. In one embodiment, a webcam 330 is a networked digital camera that may take still and/or moving images of the face of the viewer 320 and possibly the body of the viewer 320 as well. A webcam 330 may be used to capture one or more of the facial data and the physiological data.

The webcam 330 may refer to any camera including a webcam, a camera on a computer (such as a laptop, a net book, a tablet, or the like), a video camera, a still camera, a cell phone camera, a mobile device camera (including, but not limited to, a forward facing camera), a thermal imager, a CCD device, a three-dimensional camera, a depth camera, multiple webcams used to show different views of the viewers, or any other type of image capture apparatus that may allow captured image data to be used in an electronic system. The facial data from the webcam 330 is received by a video capture module 340 which may decompress the video into a raw format from a compressed format such as H.264, MPEG-2, or the like. The facial data may include information on action units, head gestures, smiles, brow furrows, squints, lowered eyebrows, raised eyebrows, attention, and the like.

The raw video data may then be processed for analysis of facial data, action units, gestures, and mental states 342. The facial data may further comprise head gestures. The facial data itself may include information on one or more of action units, head gestures, smiles, brow furrows, squints, lowered eyebrows, raised eyebrows, attention, and the like. The action units may be used to identify smiles, frowns, and other facial indicators of mental states. Gestures may include a head tilt to the side, a forward lean, a smile, a frown, as well as many other gestures. Physiological data may be analyzed 344 and eyes may be tracked 346. Physiological data may be obtained through the webcam 330 without contacting the individual. Respiration, heart rate, heart rate variability, perspiration, temperature, and other physiological indicators of mental state may be determined by analyzing the images. The physiological data may also be obtained by a variety of sensors, such as electrodermal sensors, temperature sensors, and heart rate sensors. The physiological data may include one of a group comprising electrodermal activity, heart rate, heart rate variability, respiration, and the like.

The eye tracking 346 which, in embodiments, is performed on a viewer may be used to identify the portion of the advertisement on which the viewer is focused. Further, in some embodiments, the process may include recording the time a viewer or viewers' eyes dwell on the rendering—eye dwell time—and associating information on the eye dwell time to the rendering and to mental states of the viewers or viewer. The eye dwell time can be used to augment the mental state information to indicate the level of interest in certain renderings or portions of renderings. The webcam observations may include a blink rate for the eyes. For example, a reduced blink rate may indicate significant engagement in what is being observed.

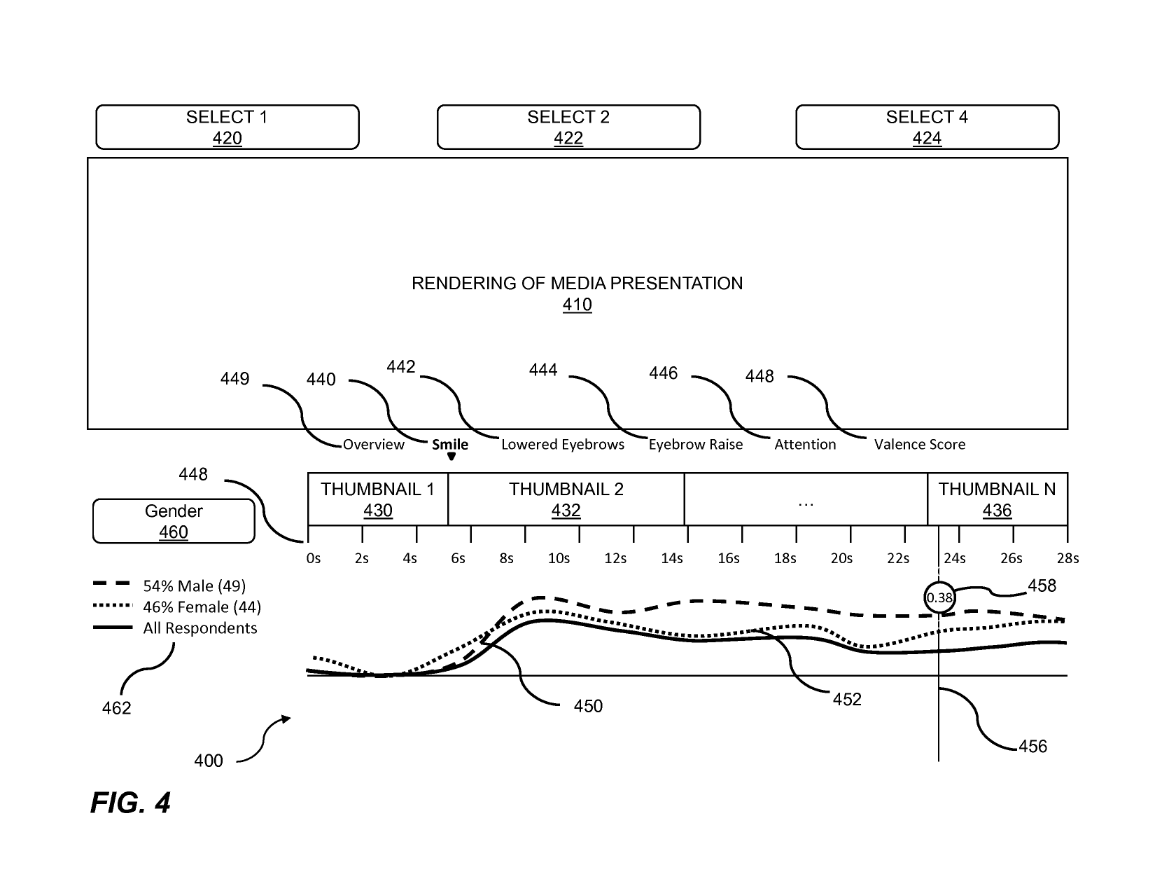

FIG. 4 shows an example dashboard diagram 400 for mental state analysis. The dashboard 400 may be shown on any type of display including, but not limited to, a television monitor, a projector, a computer monitor (including a laptop screen, a tablet screen, a net book screen, and the like), a cell phone display, a mobile device, or another electronic display. A rendering of a media presentation 410 may be presented in the dashboard 400. The example dashboard 400 shown includes the media presentation 410 along with associated mental state information. A user may be able to select among a plurality of advertisements, products, or services using various buttons and/or tabs such as Select 1 button 420, Select 2 button 422, Select 3 button 424, and so on. Other numbers of selections are possible in various embodiments. In an alternative embodiment, a list box or drop-down menu is used to present a list of advertisements or other media presentations for display. The user interface allows a plurality of parameters to be displayed as a function of time, synchronized to the advertisement. Various embodiments have any number of selections available for the user, with some being other types of renderings instead of video, including audio, text, still images, or other types of media. A set of thumbnail images for the selected rendering—in the example shown, the thumbnails include Thumbnail 1 430, Thumbnail 2 432, through Thumbnail N 436—may be shown below the rendering along with a timeline 438. The thumbnails may show a graphic “storyboard” of the media presentation 410. In some embodiments, one or more of the thumbnails are vignettes that include motion. The storyboard may assist a user in identifying a particular scene or location within the media presentation 410. Some embodiments do not include thumbnails, or may have a single thumbnail associated with the media presentation 410. Other embodiments have thumbnails of equal length while still others have thumbnails of differing lengths. In some embodiments, the start and/or end of the thumbnails is determined based on changes in the captured viewer mental states associated with the rendering, while in other embodiments the start and/or end of the thumbnails is based on particular points of interest in the media presentation 410. Thumbnails of one or more viewers may be shown in addition to, or in place of, the media-presentation thumbnails 430, 432, through 436, along the timeline 438. The thumbnails of viewers may include peak expressions, expressions at key points in the advertisement, etc.

Some embodiments may include the ability for a user to select a particular type of mental state information for display using various buttons or other selection methods. For example, in the embodiment shown in the dashboard 400, the user previously selected the Smile button 440, because smile mental state information is shown. Other types of mental state information available for user selection in various embodiments include the Lowered Eyebrows button 442, Eyebrow Raise button 444, Attention button 446, Valence Score button 448 or other types of mental state information, depending on the embodiment. In embodiments, an Overview button 449, which allows a user to show graphs of the multiple types of mental state information simultaneously, is available. The dashboard 400 may include inferred mental states about the media presentation based on the mental state data which was collected. The mental states may include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity. The mental state information may include probability information for one or more effectiveness descriptors and the probabilities for the one of the one or more effectiveness descriptors may vary for portions of the advertisement.

Because the Smile option 440 has been selected in the example shown, smile graphs are displayed. The male smile graph 450 and the female smile graph 452 are displayed in the embodiment shown, and the visual representation displays the aggregated mental state information. The mental state information may be based on various demographic groups as they react to the advertisement. The various demographic-based graphs may be indicated using various line types—as shown in FIG. 4—or may be indicated using color or another method of differentiation. A slider 456 may allow a user to select a particular time of the timeline and show the value of the chosen mental state for that particular time. The mental states can be used to analyze the effectiveness of the advertisement. The slider 456 may show the same line type or color as the demographic group whose value is shown or the slider 456 may show another line type or color. A value 458 may be included with the slider 456 to indicate a numeric representation of a specific demographic or other line shown on the dashboard 400.

In some embodiments, various types of demographic-based mental state information may be selected using the demographic button 460. Such demographics may include gender, age, race, income level, education, or any other type of demographic including dividing the respondents into those respondents that had higher reactions from those with lower reactions. In the embodiment shown, the demographic button 460 has been used to select “gender.” A graph legend 462 may be displayed indicating the various demographic groups, the line type or color for each group, the percentage of total respondents and/or absolute number of respondents for each group, and/or other information about the demographic groups. The mental state information may be aggregated according to the demographic type selected. Thus, in some embodiments, the aggregation of the mental state information is performed on a demographic basis so that mental state information is grouped based on the demographic basis.

An advertiser may be interested in observing the mental state of a particular demographic group, such as people of a certain age range or gender. In some embodiments, the mental state data may be compared with self-report data collected from the group of viewers. In this way, the analyzed mental states can be compared with the self-report information to see how well the two data sets correlate. In some instances, people may self-report a mental state other than their true mental state. For example, in some cases people may self-report a certain mental state because they feel it is the “correct” response, or they are embarrassed to report their true mental state. The self-report comparison can serve to identify advertisements where the analyzed mental state deviates from the self-reported mental state. The dashboard 400 and the analysis that it renders can be used to optimize the media presentation. In some cases different versions of the media presentation are available through the select buttons. Further, there may be additional buttons for selection which allow for various types of media presentation optimizations not mentioned in this disclosure.

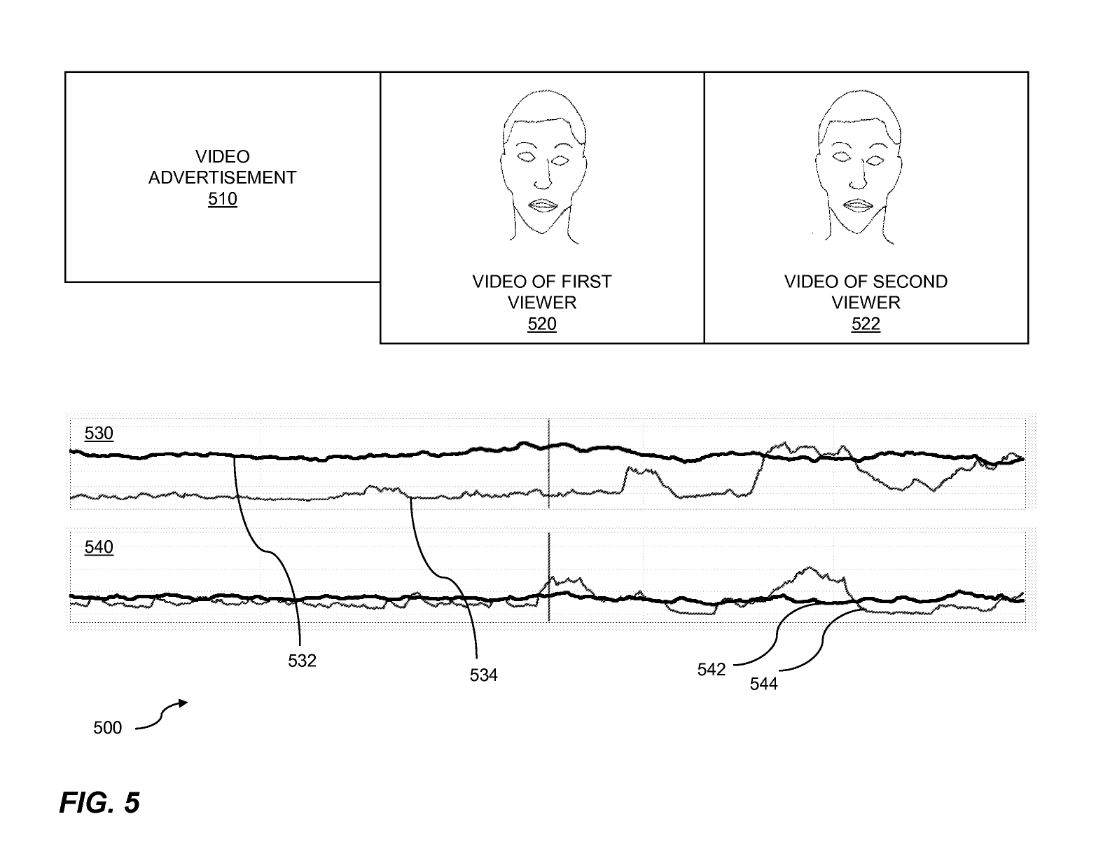

FIG. 5 shows a graphical representation 500 of mental state analysis. The representation 500 may be a visualization which is presented on an electronic display. The visualization may present all or a subset of the mental state information as well as the advertisement or a rendering based on the advertisement. The dashboard-type representation may be used to render a mental state analysis on a display. A display may be a television monitor, a projector, a computer monitor (including a laptop screen, a tablet screen, a net book screen, and the like), a projection apparatus, a cell phone display, a mobile device, or another electronic display. The representation 500 may include a video advertisement 510, a product, or a service. The video advertisement 510 may comprise a video, a still image, a sequence of still images, a set of thumbnail images, and the like. The representation 500 may also include video of a viewer or a plurality of viewers. For example, the representation 500 may include video of a first viewer 520, video of a second viewer 522, and so on. In embodiments the video for a viewer shows the viewer's reactions to the media presentation and may comprise a full motion video of the viewer, a still image of the viewer, a sequence of still images of the viewer, a set of thumbnails, and so on.

The representation 500 may allow for the comparison of graphs of various mental state parameters for a given user. The representation 500 may allow for the comparison of graphs of various mental state parameters for a plurality of viewers. The representation 500 may include inferring viewer's mental states in response to the media presentation based on the mental state data which was collected. The mental states may include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

In some embodiments, collected mental state information, such as FACS action unit data, is selected for display. For example, a graph 530 may be graphical representation of two parameters, AU4 532 and AU12 534, for the first viewer 520. Similarly, a graph 540 may be a graphical representation of two parameters, AU4 542 and AU12 544, for a second viewer 522. The graphs 530 and 540 may relate to probabilities, and in embodiments, the probabilities for one of the one or more effectiveness descriptors vary for portions of the advertisement, product, or service. Multiple other advertisement videos, video clips, stills, and the like may be shown.

For example, an advertising team may wish to test the effectiveness of an advertisement. An advertisement may be shown to a plurality of viewers in a focus group setting. The advertising team may notice an inflection point, such as a smile line, in one or more of the curves. The advertising team can then identify which point in the advertisement, in this example a product advertisement, invoked viewer smiles. Thus, content can be identified by the advertising team as being effective, or at least drawing a positive response. In this manner, viewer response can be obtained and analyzed. Once the viewer response has been analyzed, the advertisement 510 may be automatically optimized based on the viewer response.

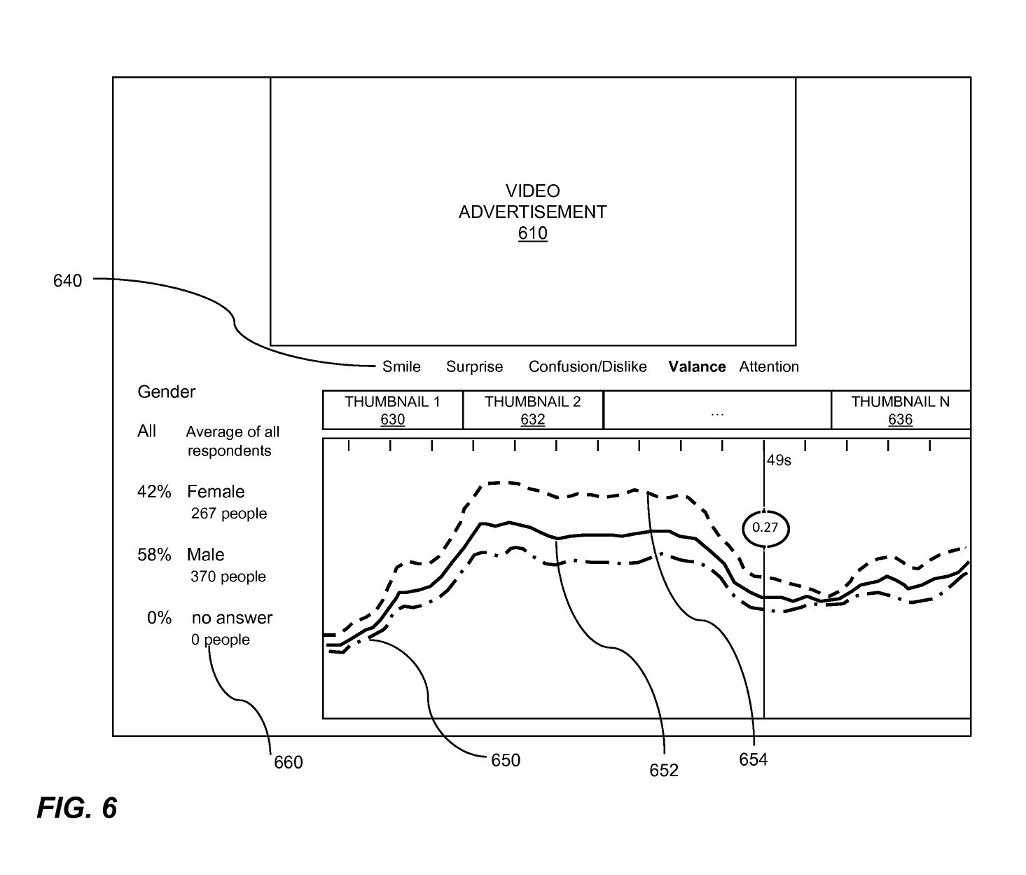

FIG. 6 shows an example advertisement dashboard 600 for mental state analysis. The dashboard 600 may include a video advertisement 610 and buttons 640 to allow different mental state information to be displayed. In the dashboard 600, the valence button has been selected. A graph 650 shows the valence of male viewers, a graph 654 shows the valence of female viewers, and a graph 652 shows the valence of the complete group of viewers through the duration of the video advertisement 610. A graph legend 660 may show how the various graphs are depicted and may provide more information, such as the number of viewers in each demographic group. A set of thumbnail images for the selected rendering—in the example shown, the thumbnails Thumbnail 1 630, Thumbnail 2 632, through Thumbnail N 636—may be shown below the rendering.

The mental state information may be used to automatically optimize the advertisement 610, and the optimizing may be done for a group of people. In various embodiments, the group represents a demographic group and/or a group which resides or works in a certain locale. The dashboard 600 may be used to identify the time of peak valence or other affect within an advertisement. By ensuring that peak valence occurs late in an advertisement and during brand reveal, an advertisement can be optimized to have the most impact. Based on this impact, sales should increase. In some embodiments, sales can be predicted based on collecting previous sales analyses and corresponding mental state data. A profile may be calculated for certain types of affect as it pertains to sales. The profile may include a graph or graph-like summary. The mental state data can be binned into discrete time regions. Based on one or more profiles, clustering or patterns can be recognized. Peak intensities can be evaluated within the discrete time intervals for certain affect measures. Two, three, or more groups of clusters can be recognized. For example a group of high-performing advertisements can be determined along with a group of poorly performing advertisements where performance correlates to sales outcomes. Distance metrics can be evaluated for the groups where a smallest distance is found that contains a group and the biggest distance is evaluated between the groups. A predictive trait may be identified for the affect-based sales information. Validation on the predictive trait can be performed using various techniques including a “leave one out” cross validation. The predication capability can be further analyzed with self-report data.

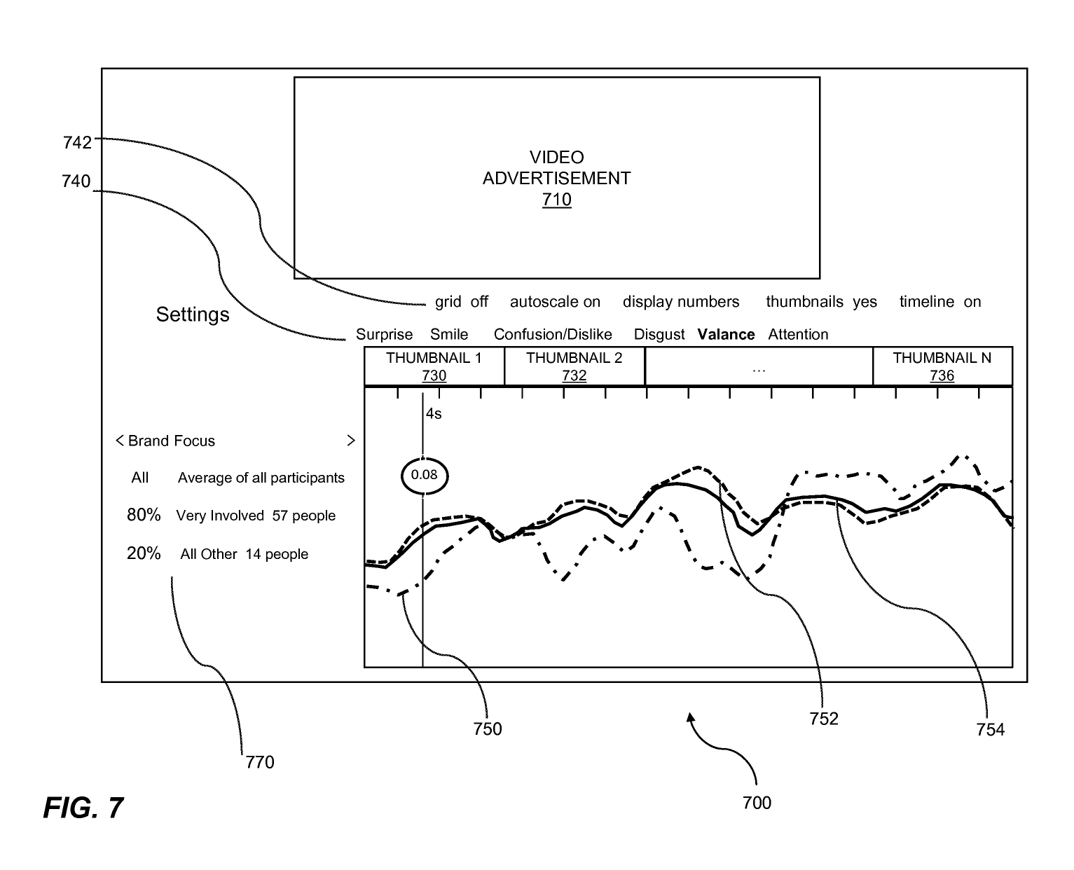

FIG. 7 shows an example advertisement dashboard 700 for valence analysis. The dashboard 700 may include a video advertisement 710 and buttons 740 to allow different mental state information to be displayed. In the dashboard 700 shown, the valence button has been selected, as well as the settings button to display various settings 742. A graph 750 shows the valence of viewers that were not very involved, a graph 752 shows the valence of viewers that were very involved, and a graph 754 shows the valence of the complete group of viewers through the duration of the video advertisement 710. A graph legend 770 may show how the various graphs are depicted and may provide more information such as the number of viewers in each demographic group. A set of thumbnail images for the selected rendering—in the example shown, the thumbnails include Thumbnail 1 730, Thumbnail 2 732, through Thumbnail N 736—may be shown below the rendering. The dashboard 700 may be used to analyze the amount of engagement for viewers of an advertisement. By optimizing the advertisement, viewer engagement can be increased. In addition, a trend over time can be observed and used to promote increased valence or engagement as advertisement progresses, in the case of a previously optimized advertisement.

The optimizing of the video advertisement 710 may be performed in a way that includes the most interesting portions of the video advertisement. In some embodiments, identifying the most interesting portions may be based on valence. Optimizing the video advertisement 710 may cut out the least interesting portions of the video advertisement. In some embodiments, the identifying of the least interesting portions may be based on valence. In some embodiments, valence may have a range that is below zero for negative feelings toward the video advertisement 710 and above zero for positive feelings toward the video advertisement 710. The portions of the advertisement identified as most interesting may be labeled as such based on an absolute valence value indicating that the viewer is not indifferent toward the video advertisement 710. The segments of the advertisement with an absolute valence score closest to zero may be identified as the least interesting portions of the advertisement.

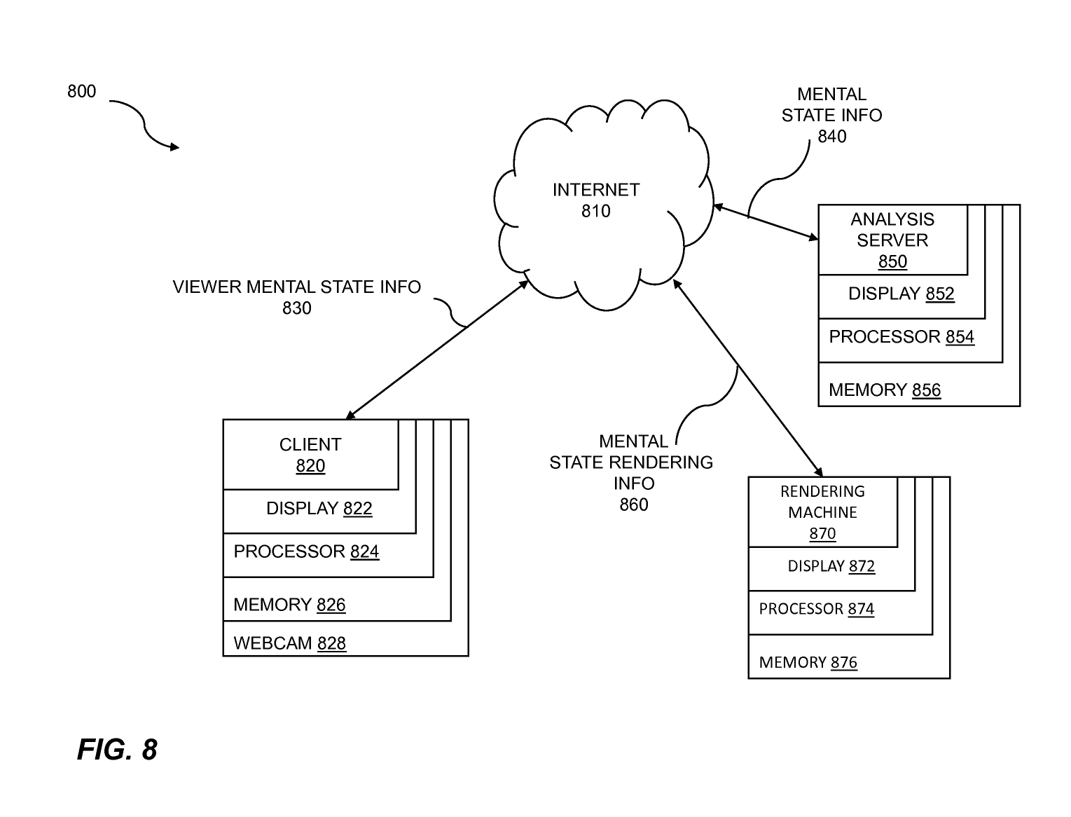

FIG. 8 is a system diagram for evaluating mental states. The diagram describes an example system 800 for media analysis. The system 800 includes one or more client machines 820 linked to an analysis server 850 via the Internet 810 or other computer network. The client machine 820 comprises one or more processors 824 coupled to a memory 826 which can store and retrieve instructions, a display 822, and a webcam 828. The display 822 may be any electronic display, including but not limited to, a computer display, a laptop screen, a net-book screen, a tablet computer screen, a cell phone display, a mobile device display, a remote with a display, a television, a projector, or the like. The webcam 828 may comprise a video camera, a still camera, a thermal imager, a CCD device, a phone camera, a three-dimensional camera, a depth camera, multiple webcams used to show different views of a person, or any other type of image capture apparatus that may allow captured data to be used in an electronic system. In embodiments, the analysis server 850 comprises one or more processors 854 coupled to a memory 856 which can store and retrieve instructions, and may include a display 852.

The processors 824 of the client machine 820 are, in some embodiments, configured to receive mental state data which was collected from a plurality of people as they view a media presentation, analyze the mental state data to produce mental state information, and optimize the media presentation based on the mental state information. In some cases, the optimization can occur in real time, based on mental state data captured using the webcam 828. In other embodiments, the processors 824 of the client machine 820 are configured to receive mental state data from one or more people as they view a media presentation, analyze the mental state date to produce mental state information, and send the viewer mental state information 830 through the internet 810 or another computer communication link to an analysis server 850. In other embodiments, the processors 824 of the client machine 820 are configured to receive mental state data from one or more people as they view a media presentation and send the mental state data to the analysis server 850.

The analysis server 850 may receive the mental state data and analyze the mental state data to produce mental state information, so that the analyzing of the mental state data may be performed by a web service. The analysis server 850 may use the mental state information received from the client machine 840 or produced from the mental state data to optimize the media presentation. In some embodiments, the analysis server 850 receives mental state data and/or mental state information from a plurality of client machines, and may aggregate the mental state information for use in optimizing the media presentation. In some embodiments, the rendering of mental state analysis and media optimization display can occur on a different computer than the collection machine 820 or the analysis server 850. This computer may be a rendering machine 870 which receives data or information 830, mental state information 840 from the analysis machine 850, or both and may be considered mental state rendering information 860. In embodiments, the rendering machine 870 includes one or more processors 874 coupled to a memory 876, and a display 872. The rendering may include generation and display of emoticons. The system 800 may include computer program product embodied in a non-transitory computer readable medium for media analysis comprising: code for collecting mental state data from a plurality of people as they view a media presentation, code for analyzing the mental state data to produce mental state information, and code for optimizing the media presentation based on the mental state information. In at least one embodiment, the client machine function and the analysis server function may be accomplished by one computer.

This invention may have been made with government support under IIP-1152261 awarded by the NSF. The government may have certain rights to the invention.

Each of the above methods may be executed on one or more processors on one or more computer systems. Embodiments may include various forms of distributed computing, client/server computing, and cloud based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are neither limited to conventional computer applications nor the programmable apparatus that run them. To illustrate: the embodiments of the presently claimed invention could include an optical computer, quantum computer, analog computer, mobile device, tablet, wearable computer or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the forgoing examples should not limit the spirit and scope of the present invention; rather it should be understood in the broadest sense allowable by law.

What is claimed is:

1. A computer-implemented method for media analysis comprising:
collecting mental state data from a plurality of people as they view a media presentation;
analyzing the mental state data to produce mental state information; and
optimizing the media presentation based on the mental state information.

2. The method of claim 1 wherein the media presentation includes an advertisement.

3. The method of claim 2 further comprising collecting the mental state data from the plurality of people for multiple viewings of the media presentation.

4. The method of claim 3 wherein the optimizing the media presentation is based on the multiple viewings.

5. The method of claim 4 wherein the optimizing is based on different responses to the multiple viewings.

6. The method of claim 1 wherein the analyzing of the mental state data is performed by a web service.

7. The method of claim 1 further comprising selecting music for the media presentation as part of the optimizing.

8. The method of claim 1 further comprising selecting characters for the media presentation as part of the optimizing.

9. The method of claim 1 further comprising determining duration for the media presentation as part of the optimizing.

10. The method of claim 1 further comprising determining advertisement placement within the media presentation as part of the optimizing.

11. The method of claim 1 further comprising determining brand reveal time for the media presentation as part of the optimizing.

12. The method of claim 1 further comprising determining optimal number of viewings for the media presentation as part of the optimizing.

13. The method of claim 1 wherein the media presentation includes an advertisement and wherein optimizing includes optimizing the media presentation for a mobile platform and further comprising:
collecting the mental state data from the plurality of people for multiple viewings of the media presentation and optimizing the media presentation is based on the multiple viewings;
determining duration for the media presentation as part of the optimizing;
determining brand reveal time for the media presentation;
developing norms based on a plurality of media presentations and where the norms are used in the optimizing of the media presentation; and
calculating an expressiveness score for the media presentation which is based on total movement for faces of the plurality of people and using the expressiveness score in the optimizing of the media presentation.

14-17. (canceled)

18. The method of claim 1 further comprising providing an engagement score for the media presentation as part of the optimizing.

19. The method of claim 18 further comprising providing an engagement score for portions of the media presentation.

20. The method of claim 18 further comprising correlating facial movement to the engagement score.

21. The method of claim 1 wherein the optimizing is based on attention.

22. (canceled)

23. The method of claim 1 wherein the optimizing is done for a group of people.

24. The method of claim 23 wherein the group represents a demographic.

25-27. (canceled)

28. The method of claim 1 further comprising determining a valence quotient.

29. (canceled)

30. The method of claim 28 wherein the media presentation is optimized to keep the valence quotient away from zero.

31-33. (canceled)

34. The method of claim 1 wherein the optimizing further comprises cutting down an existing media presentation.

35-41. (canceled)

42. The method of claim 1 wherein the optimizing selects one preamble for the media presentation from multiple possible preambles.

43. The method of claim 1 wherein the optimizing correlates to recall of the media presentation.

44. The method of claim 43 wherein the optimizing correlates to brand recall.

45. (canceled)

46. The method of claim 1 further comprising collecting self reporting from the plurality of people.

47. (canceled)

48. The method of claim 1 further comprising collecting information on whether individuals from the plurality of people eventually purchase.

49-51. (canceled)

52. The method of claim 1 further comprising developing norms based on a plurality of media presentations and where the norms are used in the optimizing of the media presentation.

53. The method of claim 1 further comprising calculating an expressiveness score for the media presentation which is based on total movement for faces of the plurality of people.

54. The method of claim 1 wherein the media presentation is optimized based on an advertisement objective which includes one or more of a group comprising entertainment, education, awareness, persuasion, startling, and drive to action.

55. The method of claim 1 further comprising predicting virality for the media presentation.

56. The method of claim 1 further comprising evaluating the media presentation based on actual sales.

57. The method of claim 1 wherein the mental state data includes one or more of smiles, laughter, smirks, or grimaces.

58. The method of claim 1 further comprising inferring mental states about the media presentation based on the mental state data which was collected where the mental states include one or more of frustration, confusion, disappointment, hesitation, cognitive overload, focusing, engagement, attention, boredom, exploration, confidence, trust, delight, disgust, skepticism, doubt, satisfaction, excitement, laughter, calmness, stress, and curiosity.

59. The method of claim 1 further comprising optimizing the media presentation to remove portions where mental state data indicated confusion.

60. The method of claim 1 wherein the optimizing is performed in real time as the media presentation is being viewed.

61. (canceled)

62. A computer program product embodied in a non-transitory computer readable medium for media analysis, the computer program product comprising:
code for collecting mental state data from a plurality of people as they view a media presentation;
code for analyzing the mental state data to produce mental state information; and
code for optimizing the media presentation based on the mental state information.

63. A computer system for media analysis comprising:
a memory which stores instructions;
one or more processors attached to the memory wherein the one or more processors, when executing the instructions which are stored, are configured to:
collect mental state data from a plurality of people as they view a media presentation;
analyze the mental state data to produce mental state information; and
optimize the media presentation based on the mental state information.

64. (canceled)
